(19) United States
(12) Patent Application Publication
(10) Pub. No.: US 2024/0326278 A1
(43) Pub. Date: Oct. 3, 2024

(54) METHOD FOR PRODUCING A FLAT PLASTIC COMPONENT FOR A MOTOR VEHICLE

(71) Applicants: Magna Engineered Glass Europe S.à.r.l., Humes - Jorquenay (FR); Magna Exteriors (Bohemia) s.r.o., Liberec (CZ)

(72) Inventors: Pierre ROBIN, Lannes (FR); Radim {hacek over (Z)}DÁRSKÝ, Liberec (CZ)

(21) Appl. No.: 18/608,986

(22) Filed: Mar. 19, 2024

(30) Foreign Application Priority Data
Mar. 30, 2023 (EP) 23165385.8

(51) Int. Cl. B26F 1/44; C09J 5/00

(52) U.S. Cl. CPC B26F 1/44; C09J 5/00; B26F 2001/4472

(57) ABSTRACT

A method for producing a flat plastic component for a motor vehicle, at least one of the two surfaces of the plastic component having an adhesive tape or an adhesive film, the plastic component and the adhesive tape or adhesive film having at least one aperture, and preferably a plurality of apertures, over the entire height of the plastic component and of the adhesive tape or adhesive film, wherein the plastic component, without apertures, is provided with the adhesive tape or adhesive film, wherein the plastic component provided with the adhesive tape or the adhesive film is placed on a die, such that the surface having the tape or film is facing the die, wherein the die has a circumferential cutting edge on the edge of each desired aperture, in that in each case a punch for each aperture presses the plastic component against the die, from the surface facing away from the die, in order to punch out the aperture, wherein each punch has a circumferential cutting edge, the cutting edges of the punches and the cutting edges of the die corresponding in each case in position and shape to one another.

### CROSS-REFERENCE TO RELATED APPLICATIONS

This application claims priority to European Patent Application No. EP 23165385.8 filed on Mar. 30, 2023. The entire disclosure of the above application is incorporated herein by reference.

### FIELD OF THE INVENTION

The invention relates to a method for producing a flat plastic component for a motor vehicle, for example a body component of a motor vehicle.

### BACKGROUND INFORMATION

For the production of motor vehicles, it is known to use flat plastic components, for example as body components for the motor vehicle, for example for a tailgate. Some flat plastic components also have apertures, i.e. openings such as holes or elongated holes, for example for functional reasons or to achieve a desired design of the component. Such flat plastic components can be painted and can serve as a visible surface of the motor vehicle.

To create the apertures in such flat plastic components, it is known to punch out the aperture or apertures from the plastic component. If the plastic component is provided with an adhesive tape or an adhesive film, the apertures are usually made in the plastic component before the adhesive tape or the adhesive film is applied, and a pre-cut adhesive tape or adhesive film is then attached to the plastic component provided with the apertures.

Such a manufacturing process is time-consuming and it is difficult to avoid the formation of burrs on the plastic component and on the adhesive tape or the adhesive film and thus difficult to produce a visually attractive surface.

### SUMMARY OF THE INVENTION

An object of the invention is therefore to specify an improved method for producing such a flat plastic component for a motor vehicle, which can be carried out simply and inexpensively and through which a visually attractive surface is produced without cutting burrs.

The object of the invention is achieved by a method for producing a flat plastic component for a motor vehicle, at least one of the two surfaces of the plastic component having an adhesive tape or an adhesive film, the plastic component and the adhesive tape or adhesive film having at least one aperture, and preferably a plurality of apertures, over the entire height of the plastic component and of the adhesive tape or adhesive film, wherein the plastic component, still without apertures, is provided with the adhesive tape or adhesive film, in that the plastic component which is provided with the adhesive tape or adhesive film is placed on the die, such that the surface having the tape or film is facing the die, the die having a circumferential cutting edge on the edge of each desired aperture, in that in each case a punch for each aperture presses the plastic component against the die, from the side facing away from the die, in order to punch out the aperture, the punch also having a circumferential cutting edge, the cutting edges of the punches and the cutting edges of the die corresponding in each case in position and shape to one another.

According to the invention, a method for punching a plastic component, whereby the plastic component is provided with a tape or a film, the plastic being punched together with the applied adhesive tape/film. According to the invention, this is made possible with a good result by the fact that not only each punch has a cutting edge running around the punch, but also the die has cutting edges running around the desired openings, i.e. apertures. Each cutting edge on the die is assigned to a punch with its cutting edge.

The strip or film lies directly on the cutting edges of the die and is cut through by the cutting edges of the die, while the punch performs the punching from the other side and/or while a hold down element-preferably arranged on both sides of the punch-holds down the plastic component against the die.

The shape of the apertures and therefore the shape of the cutting edges of the die and the punch, can be for example circular or star-shaped or heart-shaped.

A “flat” plastic component in the context of this invention means that the component has two large surfaces—top and bottom—and end faces which are very small compared to the two surfaces. “Flat” does not mean, that the component has to be planar—it can also be bent for example.

Further advantageous embodiments and developments of the invention will become apparent from the dependent claims and from the description when considered together with the figures.

It is advantageous if each cutting edge of the die runs on its flank which is radially inward on the desired opening, straight to a tip. Also, the cutting edge of each punch runs advantageously on its flank which is radially outward on the desired opening, straight to a tip.

It is also advantageous if the cutting edges of the die have an angle of 30 to 60 degrees starting from their tip, preferably 40 to 50 degrees, particularly preferably about 45 degrees. The blades geometry can consist of more than one angle over the blade's height and/or the radiuses to shape the blades can be used.

It is furthermore advantageous if the cutting edges of the die are arranged radially outwardly around the cutting edges of the punches, wherein between the cutting edges of the die and the cutting edges of the punches—more exactly between the tips of the cutting edges of the die and the tips of the cutting edges of the punches—there is no distance or a small distance of about 0.05 mm to 1 mm, preferably a distance of about 0.2 mm.

Preferably the height of the cutting edges of the die corresponds at least to the height of the adhesive tape or adhesive film, preferably the height of the cutting edges of the die is somewhat higher than the height of the adhesive tape or adhesive film, particularly preferably about 105 percent to 150 percent of the height of the adhesive tape or adhesive film.

It is advantageous if the plastic component is painted before the apertures, i.e. the openings, are made by means of the punch and die, i.e. before stamping, and preferably also before the adhesive tape or film is applied.

### DRAWINGS

The present invention is explained in greater detail below with reference to the illustrative embodiments given in the schematic figures of the drawing, in which:

FIG. 1 shows a schematic view of a step in a method for producing a flat plastic component according to the invention; and

FIG. 2 shows a detailed view of the step in the method for producing a flat plastic component according to FIG. 1 detail A.

### DESCRIPTION OF THE INVENTION

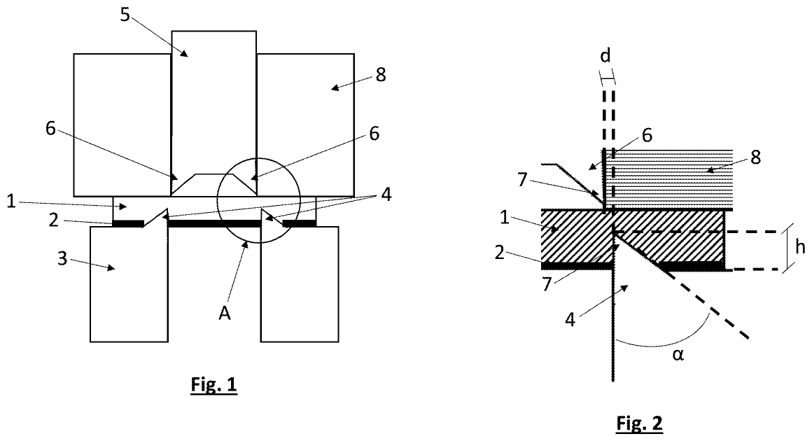

FIG. 1 shows a step in a method for producing a flat plastic component 1 having at least one opening or aperture according to the invention, and a tool for producing the flat plastic component 1.

One of the two surfaces (i.e. the top and bottom surfaces) of the plastic component 1—shown as the bottom surface of the plastic component 1 in FIG. 1—is equipped with an adhesive tape 2 or an adhesive film. The plastic component 1 has no aperture yet, as it is placed on a die 3. The surface of the plastic component 1 having the applied tape or film 2 is facing the die 3. The die 3 is shown to have a circumferential cutting edge 4 configured to define the edge of the desired aperture.

A punch 5 is provided for each desired aperture to press the plastic component 1 against the die 3, from the side facing away from the die 3, in order to punch out the aperture. Radially outside of the punch 5, a hold down element 8 is placed on the top surface of the plastic component 1 which has no tape or foil.

The punch 5 also has a circumferential cutting edge 6. The cutting edge 6 of the punch 5 and the cutting edge 4 of the die 3 correspond in position and shape to one another, i.e. the cutting edges 4, 6 of die 3 and punch 5 are arranged essentially opposite to each other, so that they can cut out the same aperture of the plastic component 1 from both sides.

The cutting edge 4 of the die 3 is arranged radially outwardly around the cutting edge 6 of the punch 5. Between the cutting edge 4 of the die 3 and the cutting edge 6 of the punch 5, there is a small distance d of about 0.05 mm to 1 mm, preferably a distance of about 0.2 mm.

The cutting edge 4 of the die 3 runs radially—concerning the aperture—on the inside straight to a tip 7 of the cutting edge 4 and the cutting edge 6 of the punch 5 runs radially—again concerning the aperture—outward straight to a tip 7 of the cutting edge 6. This can be seen best in FIG. 2, which shows the detail A from FIG. 1.

As can be seen also in FIG. 2, the two flanks of the cutting edge 4 of the die 3 have an angle α of 30 to 60 degrees starting from their tip 7, preferably 40 to 50 degrees, particularly preferably about 45 degrees.

The blades geometry—i.e. the geometry of the cutting edge—can consist of more than one angle over the blade's height and/or the radiuses to shape the blades can be used.

The height h of the cutting edge 4 of the die 3 corresponds at least to the height of the adhesive tape 2. Preferably the height h of the cutting edge 4 of the die 3 is higher than the height of the adhesive tape 2, for example about 105 percent to 150 percent of the height of the adhesive tape 2 (which is not drawn to scale in FIG. 1).

The plastic component 1 is painted before the apertures are made by means of the punch 5 and the die 3. The plastic component 1 can be used as a visible body part of the vehicle, especially as a tailgate.

What is claimed is:

1. A method for producing a flat plastic component for a motor vehicle, at least one of two surfaces of the plastic component having an adhesive tape or an adhesive film applied thereto, the plastic component with the adhesive tape or adhesive film having at least one aperture punched out over the entire height of the plastic component and of the adhesive tape or adhesive film, the method including placing the plastic component, originally without apertures, on a die such that the surface having the adhesive tape or the adhesive film faces the die, the die having a circumferential cutting edge configured to define an edge of each desired aperture, providing a punch for each of the at least one apertures which press the plastic component against the die, from the surface facing away from the die, in order to punch out the at least one aperture, the punch having a circumferential cutting edge, the cutting edge of the punch and the cutting edge of the die corresponding in each case in position and shape to one another.

2. The method according to claim 1, wherein the cutting edge of the die runs radially inward straight to a tip and/or that the cutting edge of the punch runs radially outward straight to a tip.

3. The method according to claim 1, wherein the cutting edge of the die has an angle of 30 to 60 degrees starting from its tip, preferably 40 to 50 degrees, particularly preferably about 45 degrees.

4. The method according to claim 1, wherein the cutting edge of the die is arranged radially outwardly around the cutting edges of the punch, wherein between the cutting edge of the die and the cutting edge of the punch there is no distance or a small distance of about 0.05 mm to 1 mm, preferably a distance of about 0.2 mm.

5. The method according to claim 1, wherein the height of the cutting edge of the die corresponds at least to the height of the adhesive tape or adhesive film, preferably the height of the cutting edge of the die is higher than the height of the adhesive tape or adhesive film, particularly preferably about 105 percent to 150 percent of the height of the adhesive tape or adhesive film.

6. The method according to claim 1, wherein the plastic component is painted before the at least one aperture is made by means of the punch and die, i.e. before stamping, and preferably also before the adhesive tape or film is applied.
